(19) United States
(12) Patent Application Publication
(10) Pub. No.: US 2026/0369802 A1
(43) Pub. Date: Nov. 19, 2026

(54) BATTERY HOUSING AND VENTING ELEMENTS

(71) Applicant: W. L. Gore & Associates, Inc., Newark, DE (US)

(72) Inventors: UWE BEUSCHER, Newark, DE (US); LEI ZHENG, Newark, DE (US)

(73) Assignee: W. L. Gore & Associates, Inc., Newark, DE (US)

(21) Appl. No.: 19/145,856

(22) PCT Filed: Jan. 6, 2023
(86) PCT No.: PCT/US2023/060187

§ 371 Date: Jul. 3, 2025

(51) Int. Cl. H01M 50/30; H01M 50/121; H01M 50/131; H01M 50/133

(52) U.S. Cl. CPC H01M 50/394; H01M 50/121; H01M 50/131; H01M 50/133

(57) ABSTRACT

There is provided a battery housing comprising a housing wall, the housing wall comprising a non-permeable substrate and at least one hole provided in the non-permeable substrate, the or each hole extends from a first side of the non-permeable substrate to a second side of the non-permeable substrate and the or each hole has a maximum width of from 0.1 μm to 100 μm, wherein the housing wall has a carbon dioxide (CO₂) transmission rate to water vapor (moisture) transmission rate ratio of at least 2 using the test methods as described herein.

### FIELD

The present disclosure relates to battery housings used for batteries, specifically to battery housings that allow gases to be vented from within the battery housing during use.

### BACKGROUND

Batteries, such as lithium-ion batteries, are used to power a wide array of electronic devices including automobiles and mobile phones. While enormous gains have been made in the performance of batteries over the last few decades, improvements to several aspects of battery performance (e.g., battery life, battery output, and the like) are still needed.

For example, batteries that comprise an electrolyte that can release one or more gases during operation, those gases can increase the pressure within the battery housing that, if left unchecked, can lead to ruptures in the battery housing. Accordingly, it is important that such gases can be vented to reduce the internal pressure of the battery housing.

However, vents or covers typically used in the art to allow the gas produced from decomposition of the electrolyte to be released can also allow water vapor to enter into the battery housing, thereby negatively impacting the performance and lifetime of the battery.

Therefore, there remains a need for improved batteries and improved battery housings that provide good release of gases released by an electrolyte but that further minimize the ingress of water.

Accordingly, at least some embodiments described herein provide improved solutions to venting internal gases whilst minimizing the ingress of water vapor into the battery housing.

### SUMMARY

According to a first aspect there is provided a battery housing comprising a housing wall, the housing wall comprising a non-permeable substrate and at least one hole provided in the non-permeable substrate, the or each hole extends from a first side of the non-permeable substrate to a second side of the non-permeable substrate, wherein the housing wall has a carbon dioxide (CO₂) transmission rate to water vapor (moisture) transmission rate ratio of at least 2 using the test methods as described herein.

The or each hole may have a maximum width of less than 100 μm. The or each hole may have a maximum width of less than 80 μm. The or each hole may have a maximum width of less than 60 μm. The or each hole may have a maximum width of less than 40 μm. The or each hole may have a maximum width of less than 20 μm.

The or each hole may have a maximum width of from 0.1 μm to 100 μm. The or each hole may have a maximum width of from 0.1 μm to 75 μm. The or each hole may have a maximum width of from 0.1 to 50 μm. The or each hole may have a maximum width of from 0.1 to 40 μm. The or each hole may have a maximum width of from 0.1 to 30 μm. The or each hole may have a maximum width of from 0.1 to 20 μm. The or each hole may have a maximum width of from 0.1 to 15 μm. The or each hole may have a maximum width of from 0.1 to 10 μm. The or each hole may have a maximum width of from 0.1 to 9 μm. The or each hole may have a maximum width of from 0.1 to 8 μm. The or each hole may have a maximum width of from 0.1 to 7 μm. The or each hole may have a maximum width of from 0.1 to 6 μm. The or each hole may have a maximum width of from 0.1 to 5 μm. The or each hole may have a maximum width of from 1 to 100 μm. The or each hole may have a maximum width of from 2 to 100 μm. The or each hole may have a maximum width of from 3 to 100 μm. The or each hole may have a maximum width of from 4 to 100 μm. The or each hole may have a maximum width of from 5 to 100 μm.

The or each hole may have an effective diameter of less than 100 μm. The or each hole may have an effective diameter of less than 80 μm. The or each hole may have an effective diameter of less than 60 μm. The or each hole may have an effective diameter of less than 40 μm. The or each hole may have an effective diameter of less than 20 μm.

The or each hole may have an effective diameter of from 0.1 μm to 100 μm. The or each hole may have an effective diameter of from 0.1 μm to 75 μm. The or each hole may have an effective diameter of from 0.1 to 50 μm. The or each hole may have an effective diameter of from 0.1 to 40 μm. The or each hole may have an effective diameter of from 0.1 to 30 μm. The or each hole may have an effective diameter of from 0.1 to 20 μm. The or each hole may have an effective diameter of from 0.1 to 15 μm. The or each hole may have an effective diameter of from 0.1 to 10 μm. The or each hole may have an effective diameter of from 0.1 to 9 μm. The or each hole may have an effective diameter of from 0.1 to 8 μm. The or each hole may have an effective diameter of from 0.1 to 7 μm. The or each hole may have a an effective diameter of from 0.1 to 6 μm. The or each hole may have an effective diameter of from 0.1 to 5 μm. The or each hole may have an effective diameter of from 1 to 100 μm. The or each hole may have an effective diameter of from 2 to 100 μm. The or each hole may have an effective diameter of from 3 to 100 μm. The or each hole may have an effective diameter of from 4 to 100 μm. The or each hole may have an effective diameter of from 5 to 100 μm.

As used herein, the term “effective diameter” refers to the diameter of the or each hole if it is approximated to be circular from a measured cross-sectional area.

As used herein, the term “hole” refers to a pathway or channel that allows passage of fluid from a first side of a substrate to a second side of that substrate. The pathway may be linear such that fluid may pass in a substantially straight line through the substrate. The term “hole” as used herein does not include pores that provide a tortuous pathway through a porous substrate, but rather are more direct.

The or each hole may form a direct pathway through the non-permeable substrate. The or each hole may be formed in or through the non-permeable substrate after the non-permeable substrate has been formed. Accordingly, the or each hole is not a pore of a porous material, for example.

The or each hole may have any cross-sectional shape. The or each hole may have a substantially circular, or elliptical cross-section. The or each hole may have an angular cross-sectional shape having any number of sides such as a triangular, rectangular (square or oblong), pentagonal, hexagonal or octagonal. The or each hole may have an irregular cross-sectional shape.

The or each hole may comprise an approximately cylindrical portion. The or each hole may be approximately cylindrical. Accordingly, the or each hole may have substantially the same maximum width and substantially the same cross-sectional area as the or each hole extends from the first side to the second side of the non-permeable substrate.

The or each hole may comprise an approximately conical portion. The or each hole may be approximately conical. Accordingly, the maximum width of the or each hole may increase or reduce as the or each hole extends from the first side to the second side.

The or each hole may be formed within the non-permeable substrate by any suitable method. The or each hole may be formed by mechanical drilling. The or each hole may be formed by laser drilling. In embodiments where the or each hole are formed by laser drilling the maximum width of the or each hole may slightly reduce from a first side that the laser is incident to a second side as the laser is attenuated through the non-permeable substrate. Accordingly, the or each hole may have a first maximum width or effective diameter on the first side of the non-permeable substrate and the or each hole may have a second maximum width or effective diameter on the second side of the non-permeable substrate. The first maximum width or effective diameter may be larger than the second maximum width or effective diameter. The first maximum width or effective diameter may be smaller than the second maximum width or effective diameter.

The or each hole may be formed by puncturing the non-permeable substrate. The or each hole may be formed by puncturing the non-permeable substrate by pushing or urging a puncturing element through the non-permeable substrate. The puncturing element may be a needle, capillary tube or similar.

In embodiments where more than one hole are provided in the non-permeable substrate, the more than one hole may be formed by an array of puncturing elements. The puncturing elements may be arranged in a regular pattern such that the more than one hole thereby provided in the non-permeable substrate are arranged in a regular pattern.

The housing wall may comprise at least two holes provided in the non-permeable substrate. The housing wall may comprise at least three holes provided in the non-permeable substrate. The housing wall may comprise at least four holes provided in the non-permeable substrate. The housing wall may comprise at least five holes provided in the non-permeable substrate. The housing wall may comprise at least six holes provided in the non-permeable substrate. The housing wall may comprise at least seven holes provided in the non-permeable substrate. The housing wall may comprise at least eight holes provided in the non-permeable substrate. The housing wall may comprise at least nine holes provided in the non-permeable substrate. The housing wall may comprise at least ten holes provided in the non-permeable substrate.

The housing wall may comprise from 1 to 100 holes provided in the non-permeable substrate. The housing wall may comprise from 1 to 75 holes provided in the non-permeable substrate. The housing wall may comprise from 1 to 50 holes provided in the non-permeable substrate. The housing wall may comprise from 1 to 40 holes provided in the non-permeable substrate. The housing wall may comprise from 1 to 30 holes provided in the non-permeable substrate. The housing wall may comprise from 1 to 20 holes provided in the non-permeable substrate. The housing wall may comprise from 1 to 15 holes provided in the non-permeable substrate. The housing wall may comprise from 1 to 10 holes provided in the non-permeable substrate.

In some embodiments the housing wall may have one hole provided in the non-permeable substrate. In some embodiments the housing wall may have two holes provided in the non-permeable substrate. In some embodiments the housing wall may have three holes provided in the non-permeable substrate. In some embodiments the housing wall may have four holes provided in the non-permeable substrate. In some embodiments the housing wall may have five holes provided in the non-permeable substrate.

As used herein, the “CO₂ transmission rate to water vapor transmission rate ratio” is calculated by dividing CO₂ transmission rate by water vapor transmission rate for a substrate. CO₂ transmission to water vapor transmission ratio has no units (i.e., is dimensionless). Accordingly, a ratio of at least 2 means that at least twice the volume of CO₂ is transmitted through the housing wall to that of water vapor at a given pressure.

Typically, the battery housing defines an enclosed space. The enclosed space may retain an electrolyte.

It is important to prevent the ingress of water, either in liquid or vapor form, into the interior of a battery housing, as the presence of water can significantly impact the efficiency and performance of the battery.

In addition, during the lifetime of a battery gas, such as carbon dioxide (CO₂), hydrogen (H₂), carbon monoxide (CO), or methane (CH₄), may be generated as by-products from the electrochemical reactions within the battery housing. In order to ensure that the pressure within the battery housing is maintained within operational limits to avoid ruptures of the housing wall, it is advantageous for the gas to be able to escape the interior of the battery housing.

It has been surprisingly found that the battery housing of the present aspect is able to minimise the ingress of water into the interior of the battery housing whilst allowing gasses to escape.

The CO₂ transmission rate through the housing wall may be at least 25 cm³/day. The CO₂ transmission rate through the housing wall may be at least 50 cm³/day. The CO₂ transmission rate through the housing wall may be at least 75 cm³/day. The CO₂ transmission rate through the housing wall may be at least 100 cm³/day. The CO₂ transmission rate through the housing 35 wall may be at least 150 cm³/day. The CO₂ transmission rate through the housing wall may be at least 200 cm³/day. The CO₂ transmission rate through the housing wall may be from 25 cm³/day to 10,000 cm³/day. The CO₂ transmission rate through the housing wall may be from 50 cm³/day to 10,000 cm³/day. The CO₂ transmission rate through the housing wall may be from 75 cm³/day to 10,000 cm³/day. The CO₂ transmission rate through the housing wall may be from 100 cm³/day to 10,000 cm³/day. The CO₂ transmission rate through the housing wall may be from 150 cm³/day to 10,000 cm³/day. The CO₂ transmission rate through the housing wall may be from 200 cm³/day to 10,000 cm³/day.

The CO₂ transmission rate is typically given as measured at 37.8 °C for a 5 cm² surface area at 1 bar pressure. It is to be understood that where the unit of “cm³” is used, this is the volume of gas at standard temperature and pressure (herein defined as a temperature of 0 °C and a pressure of 1 bar).

The CO₂ transmission rate through the housing wall may be at least 50,000 cm³/(m² day bar) as converted to standard temperature and pressure. The CO₂ transmission rate through the housing wall may be at least 75,000 cm³/(m² day bar). The CO₂ transmission rate through the housing wall may be at least 100,000 cm³/(m² day bar). The CO₂ transmission rate through the housing wall may be at least 150,000 cm³/(m² day bar). The CO₂ transmission rate through the housing wall may be at least 200,000 cm³/(m² day bar). The CO₂ transmission rate through the housing wall may be from 25,000 cm³/(m² day bar) to 10,000,000 cm³/(m² day bar). The CO₂ transmission rate through the housing wall may be from 50,000 cm³/(m² day bar) to 10,000,000 cm³/(m² day bar). The CO₂ transmission rate through the housing wall may be from 75,000 cm³/(m² day bar) to 10,000,000 cm³/(m² day bar). The CO₂ transmission rate through the housing wall may be from 100,000 cm³/(m² day bar) to 10,000,000 cm³/(m² day bar). The CO₂ transmission rate through the housing wall may be from 150,000 cm³/(m² day bar) to 10,000,000 cm³/(m² day bar). The CO₂ transmission rate through the housing wall may be from 200,000 cm³/(m² day bar) to 10,000,000 cm³/(m² day bar).

It will be understood that it is desirable that the water vapor transmission through the housing wall be as low as possible. For example, the water vapor transmission rate through the housing wall may be less than 200,000 cm³/(m² day bar). The water vapor transmission rate through the housing wall may be less than 150,000 cm³/(m² day bar). The water vapor transmission rate through the housing wall may be less than 100,000 cm³/(m² day bar). The water vapor transmission rate through the housing wall may be less than 75,000 cm³/(m² day bar).

The housing wall may have a CO₂ transmission rate to moisture transmission rate ratio of at least 3. The housing wall may have a CO₂ transmission rate to moisture transmission rate ratio of at least 5. The housing wall may have a CO₂ transmission rate to moisture transmission rate ratio of at least 10. The housing wall may have a CO₂ transmission rate to moisture transmission rate ratio of at least 20. The housing wall may have a CO₂ transmission rate to moisture transmission rate ratio of at least 30. It will be appreciated that it is desirable to have as high a ratio as possible for the current application to maximise the transfer rate of CO₂ out of the battery housing through the housing wall whilst minimising the transfer rate of water into the battery housing.

The housing wall may have a CO₂ transmission rate to moisture transmission rate ratio of from 2 to 1000. The housing wall may have a CO₂ transmission rate to moisture transmission rate ratio of from 3 to 1000. The housing wall may have a CO₂ transmission rate to moisture transmission rate ratio of from 5 to 1000. The housing wall may have a CO₂ transmission rate to moisture transmission rate ratio of from 10 to 1000. The housing wall may have a CO₂ transmission rate to moisture transmission rate ratio of from 20 to 1000. The housing wall may have a CO₂ transmission rate to moisture transmission rate ratio of from 30 to 1000. The housing wall may have a CO₂ transmission rate to moisture transmission rate ratio of from 50 to 1000.

The CO₂ transmission rate as discussed herein is CO₂ transmission rate as measured at 37.8 °C using the method as described below. The moisture or water vapor transmission rate as discussed herein is moisture or water vapor transmission rate as measured at 37.8 °C using the method as described below. The volume of gas was converted from the measured temperature to standard temperature and pressure as described above.

As used herein, the term “non-permeable substrate” refers to a substrate that has a low water vapor transmission rate. As used herein, a low water (moisture) vapor transmission rate is understood to be a moisture vapor transmission rate of less than 5 g/(m² day) at 100% RH at 37.8 °C or 100,000 cm³/(m² day bar).

The non-permeable substrate may comprise a polymer. The polymer may be a fluoropolymer. The polymer may be a non-fluoropolymer. The polymer may be an expanded polymer. The polymer may be a densified expanded polymer.

For the avoidance of doubt, the term “densified expanded polymer membrane” refers to a polymer membrane that has been expanded below its melting temperature and then after expansion has been densified. Accordingly, it will be understood that the density of the at least one densified expanded polymer membrane is greater than the density of a corresponding expanded polymer membrane that has not been densified. It will be understood to the person skilled in the art that a polymer membrane that has been expanded below its melting temperature and then densified may have a lower porosity than a corresponding polymer membrane of the same material that has been expanded but has not been densified. The step of densification may close a proportion of the pores in the expanded polymer membrane. Therefore, the degree to which an expanded polymer membrane has been densified may allow the permeation of gases across that membrane to be controlled and tailored to the required use.

The polymer may be selected from polytetrafluoroethylene (PTFE), polypropylene (PP), polyethylene (PE), perfluoro (alkylvinyl ether) (“PAVE”, including perfluoro(methylvinyl ether), perfluoro (ethylvinyl ether), perfluoro (propylvinyl ether) etc), vinylidene fluoride (VDF), fluorinated ethylene propylene (FEP), chlorotrifluoroethylene (CTFE) or co-polymers or combinations thereof.

The non-permeable substrate may comprise a metal. For example, the non-permeable substrate may comprise aluminium, iron, copper, tin, or alloys or combinations thereof.

The non-permeable substrate may have a thickness between the first side and the second side. The ratio of the non-permeable substrate thickness to the maximum width of the or each hole may be at least 3. The ratio of the non-permeable substrate thickness to the maximum width of the or each hole may be at least 5. The ratio of the non-permeable substrate thickness to the maximum width of the or each hole may be at least 7. The ratio of the non-permeable substrate thickness to the maximum width of the or each hole may be at least 10. The ratio of the non-permeable substrate thickness to the maximum width of the or each hole may be at least 15. The ratio of the non-permeable substrate thickness to the maximum width of the or each hole may be at least 20. The ratio of the non-permeable substrate thickness to the maximum width of the or each hole may be at least 25. Accordingly, the ratio of the non-permeable substrate thickness to the maximum width of the or each hole may be at least 3, 5, 7, 10, 15, 20, 25 or values in between.

The ratio of the non-permeable substrate thickness to the maximum width of the or each hole may be from 3 to 100. The ratio of the non-permeable substrate thickness to the maximum width of the or each hole may be from 5 to 100. The ratio of the non-permeable substrate thickness to the maximum width of the or each hole may be from 7 to 100. The ratio of the non-permeable substrate thickness to the maximum width of the or each hole may be from 10 to 100. The ratio of the non-permeable substrate thickness to the maximum width of the or each hole may be from 15 to 100. The ratio of the non-permeable substrate thickness to the maximum width of the or each hole may be from 20 to 100. The ratio of the non-permeable substrate thickness to the maximum width of the or each hole may be from 25 to 100. The ratio of the non-permeable substrate thickness to the maximum width of the or each hole may be from 2 to 90. The ratio of the non-permeable substrate thickness to the maximum width of the or each hole may be from 2 to 80. The ratio of the non-permeable substrate thickness to the maximum width of the or each hole may be from 2 to 70. The ratio of the non-permeable substrate thickness to the maximum width of the or each hole may be from 2 to 60.

The ratio of the non-permeable substrate thickness to the cross-sectional area of the or each hole may be at least 0.1 per μm. The ratio of the non-permeable substrate thickness to the cross-sectional area of the or each hole may be at least 0.5 per μm. The ratio of the non-permeable substrate thickness to the cross-sectional area of the or each hole may be at least 0.6 per μm. The ratio of the non-permeable substrate thickness to the cross-sectional area of the or each hole may be at least 0.7 per μm. The ratio of the non-permeable substrate thickness to the cross-sectional area of the or each hole may be at least 0.8 per μm. The ratio of the non-permeable substrate thickness to the cross-sectional area of the or each hole may be at least 0.9 per μm. The ratio of the non-permeable substrate thickness to the cross-sectional area of the or each hole may be at least 1 per μm.

The ratio of the non-permeable substrate thickness to the cross-sectional area of the or each hole may be from 0.1 to 1000 per μm. The ratio of the non-permeable substrate thickness to the cross-sectional area of the or each hole may be from 0.1 to 750 per μm. The ratio of the non-permeable substrate thickness to the cross-sectional area of the or each hole may be from 0.1 to 500 per μm. The ratio of the non-permeable substrate thickness to the cross-sectional area of the or each hole may be from 0.1 to 250 per μm. The ratio of the non-permeable substrate thickness to the cross-sectional area of the or each hole may be from 0.1 to 100 per μm. The ratio of the non-permeable substrate thickness to the cross-sectional area of the or each hole may be from 0.5 to 1000 per μm. The ratio of the non-permeable substrate thickness to the cross-sectional area of the or each hole may be from 1 to 1000 per μm. The ratio of the non-permeable substrate thickness to the cross-sectional area of the or each hole may be from 2 to 1000 per μm.

The battery housing may comprise at least one protective element provided on at least one of the first side and the second side of the non-permeable substrate and may cover the or each hole. The at least one protective element may prevent the ingress of particulates into the or each hole. The at least one protective element may prevent the ingress of liquids into the or each hole. The battery housing may comprise two protective elements. The two protective elements may comprise a first protective element provided on the first side and a second protective element provided on the second side such that the or each hole is covered by both the first protective element and the second protective element. Accordingly, the a first end of the or each hole may be covered by the first protective element and a second end of the or each hole may be covered by the second protective element.

The at least one protective element may comprise an open material.

As used herein, the term “open material” refers to a material that has high porosity and a low resistance to gas flow through it. In the context of the present aspect, an open material has a higher CO₂ transmission rate through it than the housing wall so as not to limit the CO₂ transmission rate through the or each hole within the non-permeable substrate of the housing wall.

The at least one protective element may comprise a highly porous material. The at least one protective element may comprise a material that has a higher CO₂ transmission rate than the housing wall. Accordingly, the CO₂ transmission rate across the battery housing is not limited by the at least one protective element and is rather limited by the CO₂ transmission rate of the housing wall. The at least one protective element may have a CO₂ transmission rate of at least 200,000,000 cm³/(m² day bar). The at least one protective element may have a CO₂ transmission rate of at least 300,000,000 cm³/(m² day bar). The at least one protective element may have a CO₂ transmission rate of at least 400,000,000 cm³/(m² day bar). The at least one protective element may have a CO₂ transmission rate of at least 500,000,000 cm³/(m² day bar). The at least one protective element may have a CO₂ transmission rate of at least 600,000,000 cm³/(m² day bar). The at least one protective element may have a CO₂ transmission rate of at least 700,000,000 cm³/(m² day bar). The at least one protective element may have a CO₂ transmission rate of at least 800,000,000 cm³/(m² day bar). The at least one protective element may have a CO₂ transmission rate of at least 1,000,000,000 cm³/(m² day bar). The at least one protective element may have a CO₂ transmission rate of from about 200,000,000 cm³/(m² day bar) to about 50,000,000,000 cm³/(m² day bar). The at least one protective element may have a CO₂ transmission rate of from about 300,000,000 cm³/(m² day bar) to about 50,000,000,000 cm³/(m² day bar). The at least one protective element may have a CO₂ transmission rate of from about 400,000,000 cm³/(m² day bar) to about 50,000,000,000 cm³/(m² day bar). The at least one protective element may have a CO₂ transmission rate of from about 500,000,000 cm³/(m² day bar) to about 50,000,000,000 cm³/(m² day bar). The at least one protective element may have a CO₂ transmission rate of from about 600,000,000 cm³/(m² day bar) to about 50,000,000,000 cm³/(m² day bar). The at least one protective element may have a CO₂ transmission rate of from about 700,000,000 cm³/(m² day bar) to about 50,000,000,000 cm³/(m² day bar). The at least one protective element may have a CO₂ transmission rate of from about 800,000,000 cm³/(m² day bar) to about 50,000,000,000 cm³/(m² day bar).

The at least one protective element may comprise an expanded polymer. The at least one protective element may comprise expanded polytetrafluoroethylene or expanded polyethylene. The at least one protective element may comprise an expanded polymer comprising a fibrillated microstructure.

The at least one protective element may comprise a coating. The coating may be oleophobic. The coating may prevent or impair the passage of solvent or electrolyte from within the battery housing through the or each hole. The coating may prevent or impair wetting of the non-permeable substrate.

The at least one protective element may have a thickness of less than 200 μm. The at least one protective element may have a thickness of less than 150 μm. The at least one protective element may have a thickness of less than 100 μm. The at least one protective element may have a thickness of less than 50 μm. The at least one protective element may have a thickness of less than 40 μm. The at least one protective element may have a thickness of less than 30 μm.

The at least one protective element may have a thickness of from 1 μm to 200 μm. The at least one protective element may have a thickness of from 1 μm to 150 μm. The at least one protective element may have a thickness of from 1 μm to 100 μm. The at least one protective element may have a thickness of from 1 μm to 50 μm. The at least one protective element may have a thickness of from 1 μm to 40 μm. The at least one protective element may have a thickness of from 1 μm to 30 μm.

In some embodiments the housing wall may be rigid. Accordingly, the housing wall may be configured to resist deformation to thereby change the shape of the housing wall. Alternatively, the housing wall may be flexible. Accordingly, the housing wall may be configured to at least partially deform to thereby change the shape of the housing wall. For example, the housing wall may be a pouch-type housing wall and the battery housing may be a battery pouch.

In some embodiments, the housing wall may comprise at least one of: a metal, a metal alloy, or a combination thereof. In some embodiments, the housing wall may comprise at least one of: Iron (Fe), Aluminum (AI), or alloys thereof. In some embodiments, the housing wall may comprise at least one polymer. The at least one polymer may comprise a fluoropolymer such as PTFE, PFA, FEP or copolymers thereof. The at least one polymer may comprise a non-fluoropolymer such as polyethylene (PE), polypropylene (PP), polyethylene terephthalate (PET) or copolymers thereof. The housing wall may comprise a combination of at least one metal layer and at least one polymer layer. The housing wall may comprise at least one metal layer provided in between at least two polymer layers. Accordingly, the housing wall may comprise at least one metal layer with at least one polymer layer provided on a first side of the at least one metal layer and at least one polymer layer provided on a second side of the at least one metal layer. The at least one metal layer may thereby be protected by the at least one polymer layer on the first side and the at least one polymer layer on the second side. The at least one polymer layer on the first side may be the same as the at least one polymer layer on the second side. The at least one polymer layer on the first side may comprise the same polymer as the at least one polymer layer on the second side. The at least one polymer layer on the first side may be different to the at least one polymer layer on the second side. The at least one polymer layer on the first side may comprise a different polymer to the at least one polymer layer on the second side.

In embodiments where the housing wall comprises multiple layers, it is to be understood that the or each holes extend through each of the multiple layers to form through holes through the housing wall.

In a second aspect there is provided a venting element comprising a non-permeable substrate, the non-permeable substrate comprising at least one hole, the or each hole extending from a first side of the non-permeable substrate to a second side of the non-permeable substrate.

The or each hole may have a maximum width of less than 100 μm. The or each hole may have a maximum width of less than 80 μm. The or each hole may have a maximum width of less than 60 μm. The or each hole may have a maximum width of less than 40 μm. The or each hole may have a maximum width of less than 20 μm.

The or each hole may have a maximum width of from 0.1 μm to 100 μm. The or each hole may have a maximum width of from 0.1 μm to 75 μm. The or each hole may have a maximum width of from 0.1 to 50 μm. The or each hole may have a maximum width of from 0.1 to 40 μm. The or each hole may have a maximum width of from 0.1 to 30 μm. The or each hole may have a maximum width of from 0.1 to 20 μm. The or each hole may have a maximum width of from 0.1 to 15 μm. The or each hole may have a maximum width of from 0.1 to 10 μm. The or each hole may have a maximum width of from 0.1 to 9 μm. The or each hole may have a maximum width of from 0.1 to 8 μm. The or each hole may have a maximum width of from 0.1 to 7 μm. The or each hole may have a maximum width of from 0.1 to 6 μm. The or each hole may have a maximum width of from 0.1 to 5 μm. The or each hole may have a maximum width of from 1 to 100 μm. The or each hole may have a maximum width of from 2 to 100 μm. The or each hole may have a maximum width of from 3 to 100 μm. The or each hole may have a maximum width of from 4 to 100 μm. The or each hole may have a maximum width of from 5 to 100 μm.

The or each hole may have an effective diameter of less than 100 μm. The or each hole may have an effective diameter of less than 80 μm. The or each hole may have an effective diameter of less than 60 μm. The or each hole may have an effective diameter of less than 40 μm. The or each hole may have an effective diameter of less than 20 μm.

The or each hole may have an effective diameter of from 0.1 μm to 100 μm. The or each hole may have an effective diameter of from 0.1 μm to 75 μm. The or each hole may have an effective diameter of from 0.1 to 50 μm. The or each hole may have an effective diameter of from 0.1 to 40 μm. The or each hole may have an effective diameter of from 0.1 to 30 μm. The or each hole may have an effective diameter of from 0.1 to 20 μm. The or each hole may have an effective diameter of from 0.1 to 15 μm. The or each hole may have an effective diameter of from 0.1 to 10 μm. The or each hole may have an effective diameter of from 0.1 to 9 μm. The or each hole may have an effective diameter of from 0.1 to 8 μm. The or each hole may have an effective diameter of from 0.1 to 7 μm. The or each hole may have a an effective diameter of from 0.1 to 6 μm. The or each hole may have an effective diameter of from 0.1 to 5 μm. The or each hole may have an effective diameter of from 1 to 100 μm. The or each hole may have an effective diameter of from 2 to 100 μm. The or each hole may have an effective diameter of from 3 to 100 μm. The or each hole may have an effective diameter of from 4 to 100 μm. The or each hole may have an effective diameter of from 5 to 100 μm.

The venting element may comprise a first protective element. The first protective element may be positioned on the first side of the non-permeable substrate and may occlude the or each hole. The venting element may comprise a second protective element. The second protective element may be positioned on the second side of the non-permeable substrate and may occlude the or each hole.

The first protective element and the second protective element may comprise an expanded polymer selected from expanded polytetrafluoroethylene and expanded polyethylene.

Each of the first protective element and the second protective element may have a higher CO₂ transmission rate than the or each hole.

The first and/or second protective element may comprise a coating. The coating may be oleophobic. The coating may prevent or impair the passage of solvent or electrolyte through the or each hole. The coating may prevent or impair wetting of the non-permeable substrate.

The venting element may comprise at least two holes provided in the non-permeable substrate. The venting element may comprise at least three holes provided in the non-permeable substrate. The venting element may comprise at least four holes provided in the non-permeable substrate. The venting element may comprise at least five holes provided in the non-permeable substrate. The venting element may comprise at least six holes provided in the non-permeable substrate. The venting element may comprise at least seven holes provided in the non-permeable substrate. The venting element may comprise at least eight holes provided in the non-permeable substrate. The venting element may comprise at least nine holes provided in the non-permeable substrate. The venting element may comprise at least ten holes provided in the non-permeable substrate.

The venting element may comprise from 1 to 100 holes provided in the non-permeable substrate. The venting element may comprise from 1 to 75 holes provided in the non-permeable substrate. The venting element may comprise from 1 to 50 holes provided in the non-permeable substrate. The venting element may comprise from 1 to 40 holes provided in the non-permeable substrate. The venting element may comprise from 1 to 30 holes provided in the non-permeable substrate. The venting element may comprise from 1 to 20 holes provided in the non-permeable substrate. The venting element may comprise from 1 to 15 holes provided in the non-permeable substrate. venting element may comprise from 1 to 10 holes provided in the non-permeable substrate.

The non-permeable substrate may comprise a polymer. The polymer may be a fluoropolymer. The polymer may be a non-fluoropolymer. The polymer may be an expanded polymer. The polymer may be a densified expanded polymer.

For the avoidance of doubt, the term “densified expanded polymer membrane” refers to a polymer membrane as defined in the first aspect.

The polymer may be selected from polytetrafluoroethylene (PTFE), polypropylene (PP), polyethylene (PE), perfluoro (alkylvinyl ether) (“PAVE”, including perfluoro(methylvinyl ether), perfluoro (ethylvinyl ether), perfluoro (propylvinyl ether) etc), vinylidene fluoride (VDF), fluorinated ethylene propylene (FEP), chlorotrifluoroethylene (CTFE) or co-polymers or combinations thereof.

The non-permeable substrate may comprise a metal. For example, the non-permeable substrate may comprise aluminium, iron, copper, tin, or alloys or combinations thereof.

The venting element may have a carbon dioxide (CO₂) transmission rate to water vapor (moisture) transmission rate ratio of at least 2 using the test methods as described herein.

The CO₂ transmission rate through the venting element may be at least 25 cm³/(day). The CO₂ transmission rate through the venting element may be at least 50 cm³/day. The CO₂ transmission rate through the venting element may be at least 75 cm³/day. The CO₂ transmission rate through the venting element may be at least 100 cm³/day. The CO₂ transmission rate through the venting element may be at least 150 cm³/day. The CO₂ transmission rate through the venting element may be at least 200 cm³/day. The CO₂ transmission rate through the venting element may be from 25 cm³/day to 10,000 cm³/day. The CO₂ transmission rate through the venting element may be from 50 cm³/day to 10,000 cm³/day. The CO₂ transmission rate through the venting element may be from 75 cm³/day to 10,000 cm³/day. The CO₂ transmission rate through the venting element may be from 100 cm³/day to 10,000 cm³/day. The CO₂ transmission rate through the venting element may be from 150 cm³/day to 10,000 cm³/day. The CO₂ transmission rate through the venting element may be from 200 cm³/day to 10,000 cm³/day.

It will be understood that it is desirable that the water vapor transmission through the venting element be as low as possible. For example, the water vapor transmission rate through the venting element may be less than 200,000 cm³/(m² day bar). The water vapor transmission rate through the venting element may be less than 150,000 cm³/(m² day bar). The water vapor transmission rate through the venting element may be less than 100,000 cm³/(m² day bar). The water vapor transmission rate through the venting element may be less than 75,000 cm³/(m² day bar).

The venting element may be configured to be installed within an electronic housing. The venting element may be configured to be installed within a housing wall of a battery housing.

The non-permeable substrate of the venting element may be a portion of the non-permeable substrate of a housing wall. The non-permeable substrate of the venting element may be configured to be inserted into an aperture within the non-permeable substrate of a housing wall.

Accordingly, the CO₂ transmission rate across the venting element may not be limited by the first protective element or the second protective element and is rather limited by the CO₂ transmission rate of the or each hole of the non-permeable substrate.

For the avoidance of doubt, the features of the non-permeable substrate of the first aspect are features of the second aspect. Further, features of the at least one protective element of the first aspect are features of the first and second protective elements of the second aspect.

According to a third aspect there is provided a battery comprising the battery housing according the first aspect.

The battery may be a secondary battery. The secondary battery may be a lithium-ion battery.

As used herein, the term “lithium-ion battery” is any battery where lithium-ions are configured to move between a negative electrode and a positive electrode during operation of the battery. Examples of lithium-ion batteries include but are not limited to: lithium-ion polymer (LiPo) batteries, lithium sulfur (Li—S) batteries, and thin-film lithium batteries.

The positive electrode may be chosen from: Lithium Nickel Manganese Cobalt Oxide (“NMC”), Lithium Nickel Cobalt Aluminum Oxide (“NCA”), Lithium Manganese Oxide (“LMO”), Lithium Iron Phosphate (“LFP”), Lithium Cobalt Oxide (“LCO”), or any combination thereof.

The negative electrode may be chosen from: Lithium, Graphite, Lithium Titanate (“LTO”), a Tin-Cobalt alloy, or any combination thereof.

In some embodiments, the battery may comprise at least one separator. The at least one separator may comprise at least one material chosen from polypropylene, polyethylene, at least one tetrafluoroethylene (TFE) polymer or copolymer, at least one homopolymer of vinylidene fluoride, at least one hexafluoropropylene (HFP)-vinylidene fluoride copolymer, or any combination thereof.

The electrolyte may be an electrolytic solution, wherein the electrolytic solution may comprise at least one solvent and at least one electrolytic salt. The at least one solvent of the electrolytic solution may comprise at least one organic solvent. The at least one organic solvent of the electrolyte may be chosen from propylene carbonate, ethylene carbonate, diethyl carbonate (DEC), dimethyl carbonate (DMC), or mixtures thereof.

The electrolyte may comprise at least one additive, wherein the at least one additive may be configured to release the at least one gas chosen from CO₂, H₂, CO, CH₄ or any combination thereof during operation of the battery. The at least one additive may be selected from the group comprising vinylene carbonate (VC), ethylene sulfite (ES), and fluoroethylene carbonate (FEC).

The electrolyte may release the at least one gas during use of the battery. The at least one gas may be a decomposition product of the electrolyte.

The electrolyte may be impregnated within the at least one separator.

The housing wall of the battery housing may comprise an aperture and a venting element according to the second aspect installed within the aperture.

It is to be understood that the features of the battery housing of the first aspect are features of the battery housing the battery of the third aspect.

### BRIEF DESCRIPTION OF THE FIGURES

Embodiments of the present invention will now be described, by way of non-limiting example, with reference to the accompanying drawings.

FIG. 1: A cross-sectional side view of a portion of a battery housing according to an embodiment;

FIG. 2: A cross-sectional side view of a portion of a battery housing according to an embodiment;

FIG. 3: Test set up for measuring CO₂ permeability/transmission rate;

FIG. 4: Test set up for measuring water permeability/transmission rate;

FIG. 5: SEM image of an example hole with a maximum width of 5.3 μm in an aluminum substrate;

FIG. 6: SEM image of an example hole with a maximum width of 4.1 μm in a densified expanded polytetrafluoroethylene (ePTFE) substrate;

FIG. 7: A cross-sectional side view of a venting element according to an embodiment; and

FIG. 8: A cross-sectional side view of a battery housing comprising a venting element according to an embodiment.

### DETAILED DESCRIPTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

### Test Methods

### CO₂ Transmission Rate

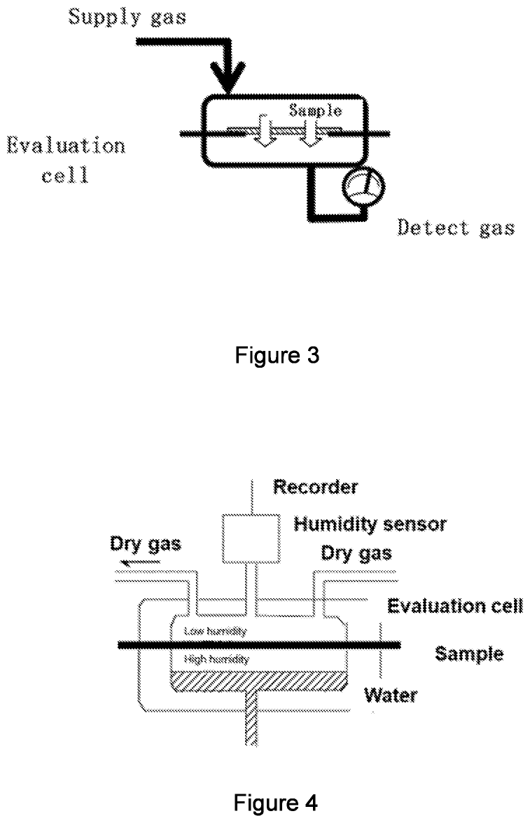

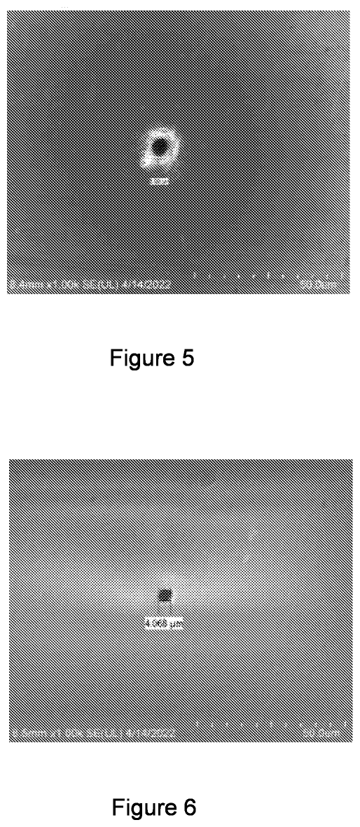

Determination of the CO₂ transmission rate through a substrate was carried out in accordance with ASTM D1434-82 (Standard Test Method for Determining Gas Permeability Characteristics of Plastic Film and Sheeting). The differential pressure test method was used. The test setup was shown in FIG. 3.

For samples with relatively low CO₂ transmission rate of less than 3,000,000 cm³/(m²·day·bar), a Labthink® Gas Permeability Tester (model VAC-V2) was used to measure the gas transmission rate of the substrate. A sample substrate was placed on an aluminum mask holder (Mocon part #052-612) with a 5 cm² opening in the center. The mask was then affixed inside an instrument testing cell and sealed in a chamber. Vacuum was applied for 25 mins to remove air in the testing chamber. Dry CO₂ gas was then introduced into the chamber on a first side of the substrate. A differential pressure across the substrate of 1 bar was conditioned for the measurement. The CO₂ that passes into the second side of the substrate through the sample substrate was detected to provide the transmission rate for that substrate. The test temperature was set at 37.8 °C. The proportional parameter was set at 10%. CO₂ transmission rate was reported by the instrument in the unit cm³/(m²·day·bar) and was converted to values of volume at standard temperature and pressure (temperature of 0 °C and a pressure of 1 bar).

For samples with relatively high CO₂ transmission rate of more than 3,000,000 cm³/(m²·day·bar), a Gas Permeability Analyzer GTR series by GTR Tec Corporation, Japan (model #GTR-30XAGR) using a Shimadzu GC-2014 gas chromatograph was used to measure the gas transmission rate of the substrate. A sample substrate was placed on an aluminum mask holder (Mocon part #052-612) with a 5 cm² opening in the center. The mask was cut to approximately 6×6 cm. It was then affixed inside an instrument testing cell and sealed in a chamber. Vacuum was applied for 10 min to remove air in the testing chamber. Dry CO₂ gas was then introduced into the chamber on a first side of the substrate. A differential pressure across the substrate of 1 bar was conditioned for the measurement. The CO₂ that passes into the second side of the substrate through the sample substrate was detected to provide the transmission rate for that substrate. The test temperature was set at 37.8 °C. Analyte collection time set at 5 to 10 s and GC analysis time was set at 3 min. CO₂ transmission rate was reported by the instrument in the unit cm³/(m²·day·atm). It was converted to the unit of cm³/(m²·day·bar) where values of volume are at standard temperature and pressure as defined above.

### Moisture Transmission Rate

Determination of the water vapor permeability through a substrate was carried out in accordance with ASTM F1249-20 (Standard Test Method for Water Vapor Transmission Rate Through Plastic Film and Sheeting Using a Modulated Infrared Sensor). The equal pressure method was used. The test setup was shown in FIG. 4. Specifically, the instrument used to test the water vapor transmission rate of the materials was a Water Vapor Permeation Analyzer by AMETEK/Mocon (model Permatran-W 3/34). A sample substrate was placed on an aluminum mask holder (Mocon part #052-612) with a 5 cm² opening in the center. The mask was then affixed to an instrument testing cell and sealed in a chamber. A sample substrate was provided to split a sample chamber into a first portion (high humidity chamber) and a second portion (low humidity chamber). The first portion retains water to create a high humidity side of the sample substrate. Dry nitrogen gas was passed through the second side to provide a low humidity side of the sample substrate. Both the first portion and the second portion of the chamber are maintained at ambient pressure. The test was performed at 100% Relative Humidity at 37.8 °C on the high humidity side. The water vapor that passes from the first side of the substrate on the high humidity side into the second side of the substrate on the low humidity side through the sample substrate in the “dry gas” outlet was detected to thereby measure the water vapor that has passed through the sample substrate. Water vapor transmission rate was reported by the instrument in the unit of g/(m²·day).

Water vapor transmission rate was converted to the unit of cm³/(m²·day·bar) using the ideal gas law and dividing by the partial water vapor pressure differential (0.066 bar) where volume was converted to that for standard temperature and pressure as defined above. Both carbon dioxide (CO₂) transmission rate and water vapor (moisture) transmission rate in the unit of cm³/(m²·day·bar) where volume was converted to that for standard temperature and pressure as defined above were used to calculate carbon dioxide (CO₂) transmission rate to water vapor (moisture) transmission rate ratio by dividing the CO₂ transmission rate by the water vapor transmission rate. CO₂ transmission to water vapor transmission ratio has no units (i.e., is dimensionless).

### Physical Parameters

Image analysis is used to calculate the surface area of the hole from an SEM image. The effective diameter of the hole is calculated from the measured area of the hole on the laser exit side. Image analysis is used to estimate the maximum width of the hole from an SEM image.

Substrate thickness of polymer films was measured using a Mitutoyo Litematic VL50S thickness gauge. Substrate thickness of Aluminum foils was measured using a Mitutoyo 547-400S Digimatic thickness gauge.

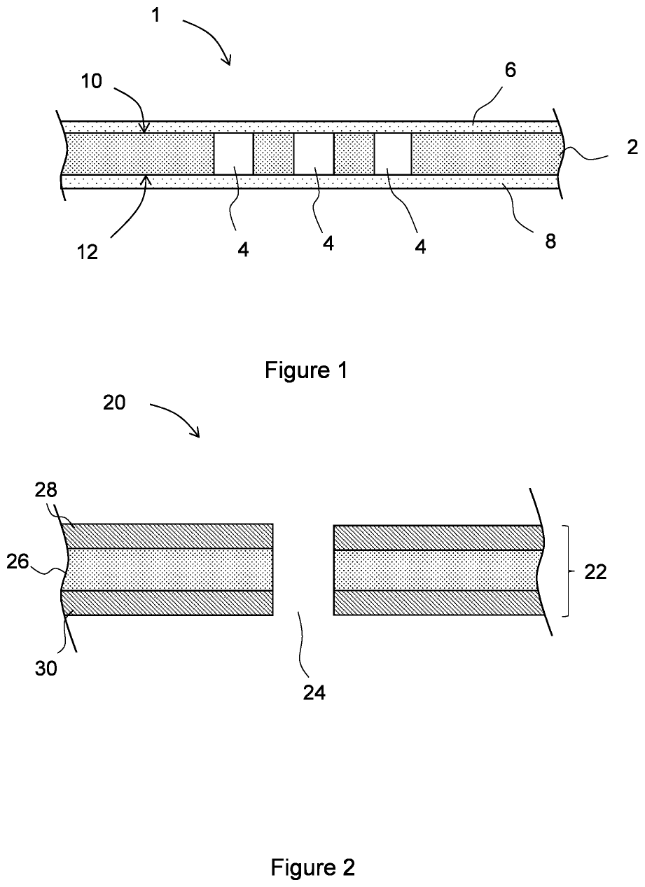

With reference to FIG. 1, a battery housing 1 comprising a housing wall 2, three holes 4 formed in the housing wall 2, a first protective layer 6 (acting as an at least one protective element), and a second protective layer 8 (acting as a further at least one protective element).

The housing wall 2 comprises an aluminum (Al) foil that has a thickness of 29.3 μm and the three holes 4 extend through the housing wall 2 from a first side 10 to a second side 12. The three holes 4 have a generally circular cross-section and have a diameter (corresponding to a maximum width) of 4 μm. The first protective layer 6 and the second protective layer 8 comprise expanded polytetrafluoroethylene (ePTFE). The first protective layer 6 is provided on the first side 10 and the second protective layer 8 is provided on the second side 12. The first protective layer 6 and the second protective layer 8 cover the three holes 4 to prevent particulates entering or blocking one or more of the three holes 4 to ensure that the three holes 4 are able to vent any gases that may be generated within the battery housing 1.

With reference to FIG. 2, a battery pouch 20 (acting as a battery housing) comprises a pouch wall 22 (acting as a housing wall) and one hole 24 formed in the pouch wall 22. The pouch wall 22 had a thickness of 100 μm and comprises an aluminum foil 26, a polyethylene terephthalate (PET) layer 28 facing the outside of the battery pouch, and a polypropylene layer 30 facing the inside of the battery pouch. The aluminum foil 26 is provided between the polyethylene terephthalate layer 28 and the polypropylene layer 30. The one hole 24 has an approximately elliptical cross-section and has a maximum width of 12 μm.

In an alternative embodiment of that shown in FIG. 2, a first protective layer and a second protective layer is provided over the hole 24 to prevent the hole 24 being blocked by particulates, for example. The first protective layer and the second protective layer comprise expanded ultra-high molecular weight polyethylene.

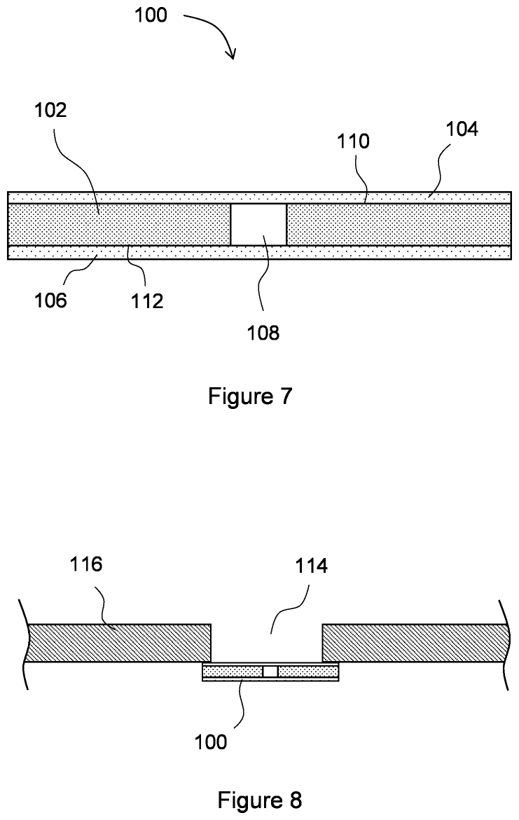

With reference to FIG. 7, a venting element 100 comprises a densified ePTFE substrate 102 (acting as a non-permeable substrate), a first ePTFE membrane 104 (acting as a first protecting element) and a second ePTFE membrane 106 (acting as a second protective element). A single 5 μm hole 108 was drilled through the substrate 102. The substrate 102 was 25 μm thick. The first ePTFE membrane 104 and second ePTFE membrane 106 occluded the hole 108 on a first side 110 of the substrate 102 and on a second side 112 of the substrate 102 respectively.

With reference to FIG. 8, the venting element 100 was installed over an aperture 114 in a battery housing 116.

### Examples

Specific example embodiments are provided in Table 1 and the measured performance of those examples are provided in Table 2.

The PTFE substrate material used in Examples 1 and 2 below was made using the following method.

The PTFE resin was mixed with lubricant (Isopar K, Exxon, Houston, TX), at a concentration of 0.167 g/g, subsequently blended, compressed into a cylindrical pellet, and thermally conditioned for 24 hours at a temperature of 70 °C. The cylindrical pellet was then extruded into a tape with thickness of 0.711 mm through a rectangular die at a reduction ratio of 88. The resultant tape was then dried in order to remove the lubricant.

The dried PTFE tape was then expanded in the y-direction between heated drums at a linear rate of about 46%/second, a drum temperature of 315 °C, and stretch amount equal to 1,032%. The tape was then expanded in the x-direction at a linear rate of about 56%/second, a temperature of about 300 °C, and a stretch amount equal to 2,863%. The resulting product was an unsintered expanded PTFE membrane with a density of about 0.20 g/cm³.

The resulting unsintered expanded PTFE membrane was compressed and densified at a temperature of 370 °C and a pressure of 1724 kPa (250 psi) based on the teachings of US patents U.S. Pat. Nos. 5,374,473 and 7,521,010 B2. The resulting article is a sintered and densified ePTFE film with a thickness of about 24 μm.

TABLE 1
Example substrates according to specific embodiments.

| | | | Maximum | Effective | | | Thickness/ |
|---|---|---|---|---|---|---|---|
| | | | Width of | Diameter | | | Cross- |
| | | | the Hole | on Exit | | Thickness/ | Sectional |
| | Substrate | # of | on the Exit | Side | Thickness, | Maximum | Area |
| Example | Material | Holes | Side (μm) | (μm) | T (μm) | Width | (/μm) |
| 1 | PTFE | 0 | — | — | 24 | — | — |
| 2 | PTFE | 1 | 5 | 5 | 25 | 5.0 | 1.3 |
| 3 | PCTFE | 0 | — | — | 51 | — | — |
| 4 | PCTFE | 1 | 4 | 4 | 51 | 12.8 | 4.1 |
| 5 | PP | 0 | — | — | 506 | — | — |
| 6 | PP | 1 | 6 | 6 | 506 | 84.3 | 17.9 |
| 7 | Al | 1 | 4 | 4 | 26 | 6.5 | 2.1 |
| 8 | Al | 1 | 6 | 6 | 53 | 8.8 | 1.9 |
| 9 | Al | 2 | 6 | 6 | 53 | 8.8 | 1.9 |
| 10 | Al | 3 | 6 | 6 | 53 | 8.8 | 1.9 |
| 11 | Al | 1 | 8 | 8 | 104 | 13.0 | 2.0 |
| 12 | Al | 2 | 8 | 8 | 104 | 13.0 | 2.0 |
| 13 | Al | 3 | 8 | 8 | 104 | 13.0 | 2.0 |
| 14 | Al | 1 | 13 | 13 | 104 | 8.0 | 0.8 |
| 15 | Al | 1 | 51 | 51 | 104 | 2.0 | 0.05 |
| 16 | Al | 1 | 12 | 12 | 407 | 33.9 | 3.6 |
| 17 | PP-Al- | 1 | 25 | 17 | 153 | 9.0 | 0.7 |
| | Nylon- | | | | | | |
| | PET | | | | | | |

In the above examples 2, 4, 6, 7-14, 16, 17 the holes were formed by laser drilling and the effective hole size on the exit side referred to in Table 1 above refers to the side of the substrate opposite to the side to which the laser was applied to form the hole (i.e. the side from which the laser “exited” the substrate). In the example 15, the holes were formed by mechanical drilling using a 50 μm drill bit.

50 μm thick PCTFE film was obtained from Honeywell (Hydroblock P2000TRI). 500 μm polypropylene film was obtained from McMaster-Carr (part #5895N112). 25 μm, 50 μm thick aluminum foils were obtained from Grainger (part #4UGH8 and #4UGJ1). 100 μm aluminum foils were obtained from McMaster-Carr (part #9708K54). 400 μm Aluminum sheet (6061-T6) was obtained from Xometry Supplies. (nominal thicknesses as received from manufacturer).

The composite film PP-Al-Nylon-PET is a standard material for a pouch battery housing. It was obtained from Dai Nippon Printing Co., Ltd. (part #D-EL408PH). The total thickness is 153 μm with about 40 μm thick Aluminum, about 80 μm polypropylene, about 12 μm PET and about 15 μm nylon.

TABLE 2
Performance of the specific examples.

| | CO₂/ | | | Moisture | | |
|---|---|---|---|---|---|---|
| | Moisture | | | vapor TR | Moisture | Moisture |
| | vapor TR | CO₂ TR, | CO₂ TR, | at | vapor TR, | vapor TR, |
| | ratio, | cm³/(m² day | cm³/day @1 bar | 100% RH, | cm³/(m² day | cm³/day @1 bar |
| Example | unitless | bar) | @5 cm² | g/(m² day) | bar) | @5 cm² |
| 1 | 0.6 | 28,530 | 14 | 2.5 | 47,721 | 23.9 |
| 2 | 3.2 | 185,886 | 93 | 3 | 57,265 | 28.6 |
| 3 | 0.2 | 1,225 | 0.6 | 0.34 | 6,490 | 3.2 |
| 4 | 19 | 150,439 | 75 | 0.41 | 7,826 | 3.9 |
| 5 | 0.4 | 7,974 | 4.0 | 1.03 | 19,661 | 9.8 |
| 6 | 15 | 288,434 | 144 | 1 | 19,088 | 9.5 |
| 7 | 39 | 207,092 | 104 | 0.28 | 5,345 | 2.7 |
| 8 | 90 | 342,233 | 171 | 0.2 | 3,818 | 1.9 |
| 9 | 80 | 761,334 | 381 | 0.5 | 9,544 | 4.8 |
| 10 | 118 | 1,346,560 | 673 | 0.6 | 11,453 | 5.7 |
| 11 | 109 | 871,891 | 436 | 0.42 | 8,017 | 4.0 |
| 12 | 90 | 1,299,046 | 650 | 0.76 | 14,507 | 7.3 |
| 13 | 111 | 2,547,421 | 1,274 | 1.2 | 22,906 | 11.5 |
| 14 | 385 | 4,993,984 | 2,497 | 0.68 | 12,980 | 6.5 |
| 15 | 31 | 46,163,670 | 23,082 | 78.9 | 1,506,075 | 753 |
| 16 | 240 | 1,556,282 | 778 | 0.34 | 6,490 | 3.2 |
| 17 | 83 | 426,020 | 213 | 0.27 | 5,154 | 2.6 |

TR = transmission rate as calculated for gas volumes at standard temperature and pressure as defined herein.

As can be seen above, embodiments comprising a hole having a maximum width of at least 4 μm provide far greater transmission rates of CO₂ through the substrate forming the battery housing compared to examples without a hole with surprisingly increased selectivity of the transmission rate of CO₂ compared to the transmission rate of water vapor.

While there has been hereinbefore described approved embodiments of the present invention, it will be readily apparent that many and various changes and modifications in form, design, structure and arrangement of parts may be made for other embodiments without departing from the invention and it will be understood that all such changes and modifications are contemplated as embodiments as a part of the present invention as defined in the appended claims.

1.-21. (canceled)

22. A battery housing comprising a housing wall, the housing wall comprising a non-permeable substrate and at least one hole provided in the non-permeable substrate, the each hole extends from a first side of the non-permeable substrate to a second side of the non-permeable substrate and the each hole has a maximum width of from 0.1 μm to 100 μm, wherein the housing wall has a carbon dioxide (CO₂) transmission rate to water vapor (moisture) transmission rate ratio of at least 2 as measured using the test methods as described herein.

23. The battery housing of claim 22, wherein the battery housing defines an enclosed space and the enclosed space retains an electrolyte.

24. The battery housing of claim 22, wherein the CO₂ transmission rate through the housing wall is at least 25 cm³/(day).

25. The battery housing of claim 22, wherein the housing wall has a CO₂ transmission rate to moisture transmission rate ratio of at least 3.

26. The battery housing of claim 22, wherein the non-permeable substrate has a thickness between the first side and the second side and the ratio of the non-permeable substrate thickness to the cross-sectional area of each hole is at least 0.1 per μm.

27. The battery housing of claim 22, wherein each hole has a maximum width of from 1 to 10 μm.

28. The battery housing of claim 22, wherein each hole has an effective diameter of from 0.1 μm to 100 μm.

29. The battery housing of claim 22, wherein the battery housing comprises at least one protective element provided on at least one of a first major surface and a second major surface of the non-permeable substrate and covers each hole.

30. The battery housing of claim 29, wherein the battery housing comprises two protective elements.

31. The battery housing of claim 30, wherein the two protective elements comprises a first protective element provided on the first major surface and a second protective element provided on the second major surface such that each hole is covered by the first protective element and the second protective element.

32. The battery housing of claim 29, wherein the at least one protective element comprises a material that has a higher CO₂ transmission rate than the housing wall.

33. The battery housing of claim 29, wherein the at least one protective element comprises an expanded polymer.

34. A venting element comprising a non-permeable substrate, a first protective element and a second protective element, the non-permeable substrate comprising at least one hole, the or each hole extending from a first side of the non-permeable substrate to a second side of the non-permeable substrate and each hole has a maximum width of from 0.1 μm to 100 μm, the first protective element being positioned on the first side of the non-permeable substrate occluding each hole, and the second protective element being positioned on the second side of the non-permeable substrate occluding each hole.

35. The venting element of claim 34, wherein the venting element has a carbon dioxide (CO₂) transmission rate to water vapor (moisture) transmission rate ratio of at least 2 using the test methods as described herein.

36. The venting element of claim 34, wherein the first protective element and the second protective element comprise an expanded polymer selected from expanded polytetrafluoroethylene and expanded polyethylene.

37. The venting element of any of claim 34, wherein each of the first protective element and the second protective element have a higher CO₂ transmission rate than each hole.

38. The venting element of any of claim 34, wherein the non-permeable substrate has a thickness between the first side and the second side and the ratio of the non-permeable substrate thickness to the cross-sectional area of each hole is at least 0.1 per μm.

39. The venting element of any of claim 34, wherein each hole has a maximum width of from 1 to 10 μm.

40. The venting element of any of claim 34, wherein each hole has an effective diameter of from 0.1 μm to 100 μm.

41. The venting element of any of claim 34, wherein the CO₂ transmission rate through the venting element is at least 25 cm³/(day).
